(19) United States
(12) Patent Application Publication
(10) Pub. No.: US 2004/0007299 A1
(43) Pub. Date: Jan. 15, 2004

(54) Tread for retreading tires

(76) Inventor: Eldon Dresch, Curitiby (BR)

Correspondence Address: DARBY & DARBY P.C., P. O. BOX 5257, NEW YORK, NY, 10150-5257, US

(21) Appl. No.: 10/239,069

(22) PCT Filed: Apr. 4, 2001
(86) PCT No.: PCT/BR01/00038

(30) Foreign Application Priority Data
Apr. 5, 2000 (BR) PI 0001130-4

(51) Int. Cl. B60C 11/00; B29D 30/54

(52) U.S. Cl. 152/209.6; 152/209.14; 156/96

(57) ABSTRACT

A tread for retreading tires, having an external face (21) provided with the usual grooves (23) and an internal face (22) to be seated and adhered, usually by vulcanization, to the convex external face (11) of a tire carcass (10), from which the compound of the original tread has been totally abraded, said tread (20) presenting a thickness that varies throughout the width thereof, having its internal face (22) defined in a concave arc, with the radius of curvature corresponding to that of the external face (11) of the tire carcass (10) and with its external face (21) being flat or slightly convex, with the radius of curvature substantially larger than that of its internal face (22).

### FIELD OF THE INVENTION

The present invention refers to a tread to be vulcanized to a worn and previously abraded carcass of a tire to be retreaded.

### BACKGROUND OF THE INVENTION

As is well known in the prior art, the usual procedure for the retreading of tires includes the basic step of abrading the worn tire carcass, in order to remove from the external face thereof the compound, which has been aggregated to said external face for defining the original tread, and which has worn out during the useful life of the tire.

In FIGS. 1 and 2 of the attached drawings, a prior art embodiment is illustrated, according to which the tread 20 has a substantially trapezoidal cross-section, with a thickness “E” that is substantially constant throughout the whole width thereof, said tread 20 being obtained from a compound rubber material, which is adequate to the intended use of the tire. This tread 20 known in the prior art has an external face 21 and an internal face 22 which, before the tread 20 is applied to the tire carcass 10, are substantially parallel to each other, the external face 21 being provided with the known grooves 23 presenting the depth generally employed in the conventional treads 20.

As it may be observed in FIG. 2, the tread 20 with a constant thickness “E” (illustrated in FIG. 1) is seated and secured onto the convex external face 11 of a tire carcass 10, after said carcass has been properly abraded in order to eliminate all the compound that defined the original tread (not illustrated) and which has to be removed and replaced by the new tread 20 in the retreading process.

In the construction illustrated in FIGS. 1 and 2, the tire carcass 10 undergoes a complete abrasion of the compound material of the original tread, in order that the external face 11 presents the original basic form of the tire construction, in the form of a convex arc. As a function of the convexity of the external face 11 of the tire carcass 10, the tread 20 is elastically deformed to an arcuated form, such as illustrated in FIG. 2, in order to have its internal face 22 perfectly seated and adhered to the external face 11 of the tire carcass 10.

While this prior art construction assures a secure and reliable structure for the retreaded tire, owing to the fact that the compound material of the original worn tread has been completely removed, the external face 21 of the tread 20 with a constant thickness also assumes a convex arcuated shape, as illustrated in FIG. 2.

However, when the external face 21 of the tread 20 is conducted to a convex arcuated shape, its median region will be submitted to a higher concentration of forces during the use of the tire under load, said median region of the tread being thus submitted to a much more intensive wear than the lateral regions thereof. Since this type of tread 20 has a constant thickness “E”, it is evident that this thickness has to be dimensioned as a function of the more intensive wear occurring in its central region, making said thickness be thus dimensioned as a function of a much more intensive wear during a certain initial period of the useful life of the tire, until reaching a situation in which the marginal regions of said tread 20 also receive a certain load, homogenizing the distribution of forces throughout the tread and reducing the intensity of wear in its central region.

Thus, in brief, it may be said that the thickness and thus the mass of the rubber compound, which is necessary for obtaining said treads 20 with a constant thickness “E”, is over-dimensioned in order to guarantee a determined minimum useful life for the tire, taking into account this intensive wear in the central region of said tread.

FIG. 3 illustrates another constructive option also known in the prior art, according to which the abrasion of the tire carcass 10 is carried out in order to leave aggregated to said tire carcass 10 two lateral shoulders 25 of the rubber compound of the original tread, in order to obtain a substantially flat external face 11a. In this second prior art embodiment, the tread 20 further has a substantially transversal cross-section, with its front face 21 and rear face 22 substantially parallel to each other, said tread thus having a thickness “e” that is also substantially constant along the whole width thereof. In this construction, the flat rear face 22 of the tread 20 is seated and adhered against the substantially flat external face 11a of the tire carcass 10, without being submitted to any relevant elastic deformation and allowing the front face 21 of said tread 20, already recapped to the tire carcass 10, to have also a substantially flat form, that is, with an arrangement that is capable of allowing a more homogenous distribution of the loads to be supported by the tire. Thus, the thickness “e” of this tread 20 may be dimensioned with values that are lower than those of the tread 20 of the embodiment shown in FIGS. 1 and 2, since the wear of this tread of FIG. 3 will occur in a more balanced and less intensive way through the whole width of said tread 20.

While allowing the dimensioning of the treads 20 with a constant and reduced thickness in relation to those treads that are arcuated upon assembly, this second prior art solution has the serious disadvantage of requiring that part of the fixation between the tread 20 and the tire carcass 10 occurs with the provision of circumferential shoulder portions 25 consisting of the compound of the original tread already with a high degree of wear resulting from the useful life to which the tire has been submitted. This deficiency makes the fragility of the recapped tread eliminate all the possible advantages of a possible save of material resulting from the smaller dimensioning for the thickness “e” of the tread 20.

### DISCLOSURE OF THE INVENTION

Thus, it is a general object of the present invention to provide a tread for retreading tires, which may be securely and reliably incorporated to a tire carcass with the original tread completely abraded, guaranteeing the required efficiency for the tire in terms of mileage, by substantially reducing the mass and consequently the weight of the rubber compound that forms said tread.

The tread for retreading tires of the present invention has an external face provided with the usual grooves and an internal face to be seated and adhered, usually by vulcanization, to the convex external face of a tire carcass, from which the compound of the original tread has been totally abraded.

According to the invention, the tread has a thickness that varies throughout the width thereof, having its internal face defined in a concave arc, with the radius of curvature corresponding to that of the external face of the tire carcass and with its external face being flat or slightly convex, with the radius of curvature substantially larger than that of its internal face.

As it may be observed, the shape of the cross-section imparted to the tread of the present invention allows said tread to present an internal face configured to be seated and adhered to the completely abraded concave external face of the tire carcass to be recapped, without submitting said tread to any elastic deformation during vulcanization thereof.

Thus, the external face of the tread may have a substantially flat configuration or a slight convexity concentric to that of the internal face, but with a substantially larger radius of curvature that is provided only to assure an almost flat shape to the external face of the tread when the respective retreaded tire is under load.

The secure and reliable fixation of the tread directly to the completely abraded external face 11 of the tire carcass 10, associated to the flattening or substantial flattening of the external face thereof, allows obtaining a retreaded tire tread that will suffer wear in a substantial homogeneous way throughout its width, avoiding the intensive wear of its central region and consequently the corresponding larger dimensioning of the thickness “e” of its central region, as a function of the wear that would otherwise be intensive if the external face of said tread is maintained arcuated, as it occurs in the prior art embodiment illustrated in FIGS. 1 and 2. Thus, the present invention allows the provision of a tread, which is securely affixed to a completely abraded tire carcass, and which has a rubber compound mass that is substantially reduced in relation to that used in the solution illustrated in FIGS. 1 and 2 and usually required for safety reasons regarding the tread-tire carcass fixation.

### BRIEF DESCRIPTION OF THE DRAWINGS

The invention will be described below, with reference to the attached drawings, in which:

FIG. 1 is a cross-sectional view of a prior art tread having a constant thickness and external grooves with the depth determined according to the prior art solutions;

FIG. 2 is a slightly exploded partial cross-sectional view of a tire carcass with the tire tread illustrated in FIG. 1;

FIG. 3 is a sectional view similar to that of FIG. 2, but illustrating a tire carcass, whose front face has been abraded in order to present a flat profile, as a function of two circumferential lateral shoulders formed by the original tread compound not totally removed from said tire carcass;

FIG. 4 is cross-sectional view of the tread of the present invention; and

FIG. 5 is a sectional view similar to that of FIGS. 2 and 3, but illustrating an assembly defined by a tire carcass with the convex external face completely abraded, and by the tread of the present invention illustrated in FIG. 4.

### BEST MODE FOR CARRYING OUT THE INVENTION

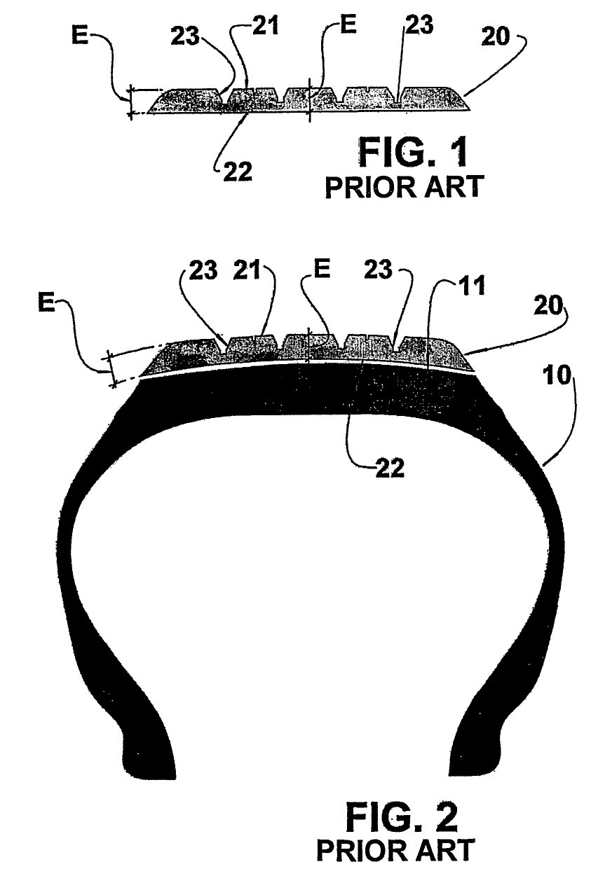

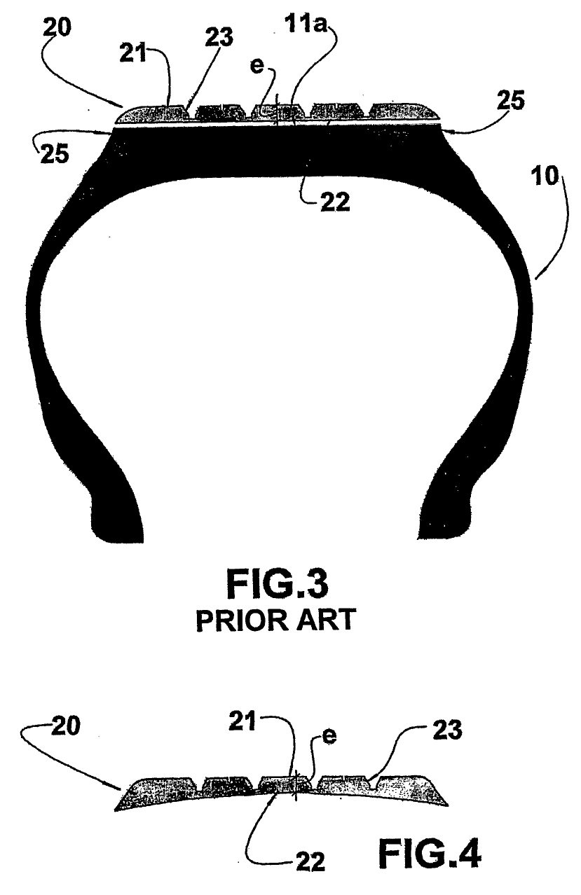

As previously described, FIGS. 1, 2 and 3 refer to two known prior art solutions for applying a tread 20 to a tire carcass 10 to be retreaded.

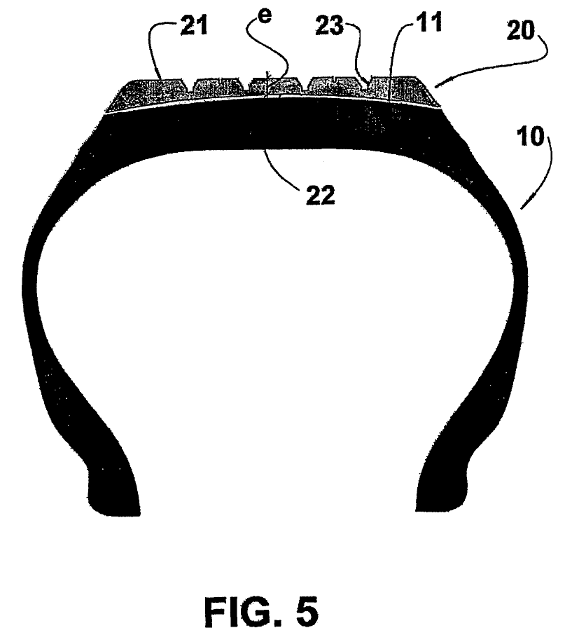

The tread 20 constructed according to the present invention is illustrated in FIGS. 4 and 5.

As illustrated, the tread 20 is conventionally constructed with the adequate rubber compounds for the intended use and presents, in a cross-sectional view, an external face 21 provided with the usual grooves 23 and an internal face 22 to be seated and adhered, usually by vulcanization, to the convex external face 11 of a tire carcass 10, from which the compound of the original tread has been completely abraded. As mentioned before, the tire carcass 10 has its external face 11 totally free from the rubber compound that formed the original worn tread, which has been completely removed from the tire carcass in order to guarantee a more secure and reliable fixation of the tread 20 during the retreading process and during the useful life of the retreaded tire to be obtained. According to the invention, the tread 20 presents a thickness “e” varying from a minimum value in its central region to higher values in its marginal regions, due to the fact that said tread 20 has its internal face 22 defined in a concave arc, with the radius of curvature corresponding to the radius of curvature of the external face 11 of the tire carcass 10, the external face 21 of the tread 10 being kept flat and slightly convex, with the radius of curvature substantially larger than that of the internal face 22.

With this arrangement, there is achieved a perfect and secure seating of the tread 20 against the tire carcass 10, while maintaining the external face 21 of the tread 20 in a configuration that leads to a better distribution of the load to be supported by the tire during its useful life. This allows to maintain the wear of the retreaded tread in more homogeneous levels throughout the whole width thereof, allowing to reduce the speed of said wear. Moreover, the required degree of tire efficiency in terms of mileage is obtained, by maintaining the thickness Be” in the central region of the tread 20 that is dimensioned as a function of said less intensive and better distributed wear. This thickness “e” is therefore inferior to that thickness “E” needed for the formation of the treads with a constant thickness, which are directly vulcanized or otherwise affixed to the concave external face 11 of a totally abraded tire carcass 10.

The small increase in the thickness of the internal marginal portions of the tread 20 of the present invention is not enough to jeopardize the mass gain and consequently the weight gain achieved with this new tread configuration.

Conventionally, the tread 20 of the present invention also presents a substantially trapezoidal cross-section, with its larger base defined by its internal face 22 in a concave arc and whose transversal extension corresponds to the transversal extension of the external face 11 of the tire carcass 10.

1. A tread for retreading tires, having an external face (21) provided with the usual grooves (23) and an internal face (22) to be seated and adhered, usually by vulcanization, to the convex external face (11) of a tire carcass (10), from which the compound of the original tread has been totally abraded, said tread (20) being characterized in that it presents a thickness varying throughout the width thereof, having its internal face (22) defined in a concave arc, with the radius of curvature corresponding to that of the external face (11) of the tire carcass (10) and with its external face (21) being flat or slightly convex, with the radius of curvature substantially larger than that of its internal face (22).

2. Tread, according to claim 1, characterized in that it has a trapezoidal cross-section, with the larger base defined by the internal face (22) in a concave arc, and whose transversal extension corresponds to the transversal extension of the external face (11) of the tire carcass (10).
